(19) United States
(12) Patent Application Publication
(10) Pub. No.: US 2026/0005618 A1
(43) Pub. Date: Jan. 1, 2026

(54) CONTROL CIRCUIT

(71) Applicant: TUSAS - TÜRK HAVACILIK VE UZAY SANAYII ANONIM SIRKETI, Ankara (TR)

(72) Inventors: Serkan Murat KARABACAK, Ankara (TR); Ilyas SARIGUL, Ankara (TR)

(73) Assignee: TUSAS - TÜRK HAVACILIK VE UZAY SANAYII ANONIM SIRKETI, Ankara (TR)

(21) Appl. No.: 19/251,932

(22) Filed: Jun. 27, 2025

(30) Foreign Application Priority Data
Jun. 27, 2024 (TR) 2024/008158

(51) Int. Cl. H02M 3/335; H02M 1/00

(52) U.S. Cl. CPC H02M 3/33592; H02M 1/0009

(57) ABSTRACT

A control circuit includes at least one piece of equipment configured to perform a function specified by the manufacturer, at least one source connected to the equipment and being a source of alternating current supplying the equipment by providing voltage to the equipment, a circuit whose input is connected to the source and whose output is connected to the equipment and which controls the voltage and current transmitted from the source to the equipment, a first semiconductor connected to the source and having a switching function, at least one controller connected to the first semiconductor in the circuit, controlling the operation of the first semiconductor by controlling the current and voltage on the legs of the first semiconductor and switching the first semiconductor so that the first semiconductor converts the alternating current transmitted by the source into direct current.

### CROSS REFERENCE TO THE RELATED APPLICATIONS

This application is based upon and claims priority to Turkish Patent Application No. 2024/008158, filed on Jun. 27, 2024, the entire contents of which are incorporated herein by reference.

### TECHNICAL FIELD

This invention relates to circuits for controlling the current and voltage delivered by power supplies to electronic equipment.

### BACKGROUND

In alternating current systems and isolated switching power supplies, rectifier circuits are used for direct current conversion. These circuits are only interested in converting the voltage to direct current. These circuits are used on the secondary side of transformers used in isolated systems. However, these circuits do not provide voltage regulation and current limiting. Converter circuits are used to regulate the voltage and limit the current, but these circuits also do not convert alternating current to direct current. The use of different circuits on the secondary side of the transformer to convert alternating current to direct current and to change and limit the values of current and voltage requires extra physical space.

In the article document titled “Secondary Side Synchronous Post Regulator Provides Precision Regulation and High Efficiency for Multiple Output Isolated Power Supplies”, which is included in the known state of the art, the circuits that enable the regulation of the output voltages of power supplies with multiple output voltages are mentioned. In the document, it is mentioned that multiple isolated output voltages are regulated by means of MOSFETs and controller circuit used in the post regulator circuit. It is mentioned that both current limiting and isolated output voltage regulation are realized by means of the controller circuit and MOSFETs. The controller circuit in the document can include any control circuit that allows controlling multiple semiconductors. In addition, the document mentions that in the case of voltage regulation and current limiting, sensor units can also be included to measure current and voltage.

In the patent document originating in the United States of America with the number U.S. Pat. No. 7,119,524B2, which is included in the known state of the art, dc-dc converters used in power circuits and providing voltage regulation are mentioned. In the circuit structure where the synchronous rectifier and driver circuit are used, the control circuit drives the switching elements and controls the voltage level on the gate and source legs of the metal oxide semiconductor field effect transistors used as switching elements according to the threshold value. According to the switching states on the secondary side, voltage regulation and current limiting operations are performed by means of op-amps placed inside the transistor. In this way, a structure in which the output voltage of the power circuit is controlled is maintained.

### SUMMARY

A control circuit developed with this invention enables the alternating current or alternating current in the secondary winding of the transformer to be converted into direct current, as well as adjusting the voltage and limiting the current.

Another object of the present invention is to enable the conversion of alternating current or alternating current in the secondary winding of the transformer to direct current, as well as the adjustment of the voltage and the limiting of the current, to be carried out through the same circuit structure.

The control circuit as defined in the first claim and the dependent claims of the present invention, wherein the control circuit includes electronic equipment configured to perform functions predetermined by the manufacturer. The equipment is connected to a source, which is an alternating current source, and provides alternating current to supply the equipment. There is a circuit between the source and the equipment, with the input of the circuit connected to the source and the output connected to the equipment. The circuit measures the current and voltage transmitted from the source to the equipment and allows these values to be adjusted. The circuit contains the first semiconductor, which is the circuit element that the current from the source first contacts. The first semiconductor can be switched (switching). There is a controller connected to the first semiconductor in the circuit. The controller is directly connected to the first semiconductor and controls the voltages on the pins of the first semiconductor to convert the alternating current transmitted by the source into direct current.

The inventive control circuit includes a first transistor connected to the controller. The first transistor is connected back to back with the first semiconductor. The first transistor is directly connected to the first semiconductor and there are no other electronic elements between them. As the first semiconductor converts alternating current into direct current, the transistor controls the levels of direct current and voltage and ensures that the current does not exceed the limits predetermined by the manufacturer.

In one embodiment of the invention, the control circuit includes a rectifier circuit within the controller. The rectifier is connected directly to the first semiconductor and controls the legs of the first semiconductor, allowing rectification of alternating current to direct current.

In one embodiment of the invention, the control circuit includes a current meter circuit and a voltage meter circuit within the controller. The current meter enables a current value to be measured at points specified by the manufacturer or user in the circuit. The voltmeter allows the voltage value to be measured at points specified by the manufacturer or user in the circuit. The router is directly connected to the current meter and voltmeter. The router reads the current and voltage values measured by the current meter and voltmeter and is connected to the first transistor in such a way that the first transistor is on and off or conduction (ON) and cut-off (OFF) in the conditions specified by the manufacturer or user.

In one embodiment of the invention, the control circuit includes a router circuit which contains information on current and voltage threshold values so that the equipment operates at current and voltage values specified by the manufacturer or user. The router contains logic gates. The router compares the value measured by the current meter and voltage meter from the circuit output with the threshold values and switches off the first transistor by switching it off or cuts off its transmission if the measured voltage and current value exceeds the predetermined threshold values or goes out of the predetermined range.

In one embodiment of the invention, the control circuit includes a resistor located externally in or outside the circuit. The resistor is located close to the equipment, either inside or outside the circuit. The resistor enables a current value to be measured and a voltage value to be measured at the output of the circuit by means of a current meter and a voltage meter. The current meter measures current by connecting the resistor at both ends, while the voltmeter measures voltage at the end of the resistor close to the equipment.

In one embodiment of the invention, the control circuit includes a capacitor located in or out of the circuit so as to be directly connected to the equipment. The capacitor is discharged by supplying the equipment when the router cuts the first transistor when the current and voltage values measured at the output of the circuit exceed the threshold values and allows the equipment to continue to operate for a period of time specified by the manufacturer. When the measured voltage and current values fall below the threshold values, the router switches the first transistor into conduction and supplies the source equipment with regulated voltage and limited current. Meanwhile, the capacitor is charging.

In one embodiment of the invention, the control circuit includes a semiconductor and a first transistor arranged back-to-back. The body diodes in the semiconductor and the first transistor are in opposite directions to each other. The semiconductor converts alternating current into direct current, while the first transistor, in conduction and in cut-off, limits the direct current inverted by the semiconductor and regulates the voltage.

In one embodiment of the invention, the control circuit includes a first semiconductor which, according to their arrangement in the circuit, converts a half-wave positive phase or a half-wave negative phase of the alternating current transmitted by the source to the equipment into direct current. The semiconductor converts only the negative phase or only the positive phase to direct current, depending on its placement in the circuit. The first transistor in the circuit limits the current and regulates the voltage of only the negative phase or only the positive phase, depending on its placement in the circuit.

In one embodiment of the invention, the control circuit includes a second semiconductor and a second transistor. The second semiconductor and the second transistor are connected back to back. When the equipment is supplied by the source, a half-wave portion of the alternating current transmitted by the source is converted to direct current by the first semiconductor, while the other half-wave portion is converted to direct current by the second semiconductor. The half-wave portion of the direct current converted by the first semiconductor and the second semiconductor is limited by the first transistor and the voltage is regulated. The second transistor limits the current and regulates the voltage for the other half-wave portion. The router controls the first transistor and the second transistor. Full wave current limiting and voltage regulation is performed by the first transistor and the second transistor. The first transistor and the second transistor enter cut-off when the current and voltage values measured from the circuit output exceed the threshold value and remain in the cut-off state until the current drops below the threshold value if the current exceeds the threshold value. During this time, the voltage value decreases. When the current and voltage drop below the threshold value, the first transistor and the second transistor are switched to conduction by means of the router.

In one embodiment of the invention, the control circuit includes a control circuit, conducting alternating current into the circuit by the source, converting the positive region of the current into direct current by means of a first semiconductor, converting the negative region of the current into direct current by means of a second semiconductor, measuring current and voltage values at the output of the circuit by means of a current meter and a voltage meter through a resistor. It includes a circuit that enables the comparison of the current and voltage threshold values predetermined by the manufacturer in the router with the current measured through the resistor and the voltage values measured from the output of the circuit, controlling the positive and negative regions of the current so that the first transistor and the second transistor are in conduction or cut-off by controlling the signal by the router, and obtaining the signal determined by the manufacturer and feeding the equipment.

In one embodiment of the invention, the control circuit includes at least one second rectifier located on the high voltage side and/or on the low voltage side, either inside or outside the circuit. Preferably two third semiconductors, preferably located in the circuit at a position specified by the manufacturer or user, are switched by the second rectifier. One of the third semiconductors ensures that the circuit is completed in the case of positive half-wave current conduction, while the other ensures that the circuit is completed in the case of negative half-wave current conduction. One of the third semiconductors is connected to the first semiconductor and the first transistor placed back-to-back, while the other is connected to the second semiconductor and the second transistor placed back-to-back.

In one embodiment of the invention, the control circuit includes a transformer having electromagnetic galvanic isolation. The transformer is located between the input of the circuit and the equipment and regulates the voltage level of the current transmitted by the source to the equipment at a number of windings specified by the manufacturer. The source is located in the first zone of the transformer. In the second zone of the transformer is the circuit and the output of the circuit is connected to the equipment.

In one embodiment of the invention, the control circuit includes a first semiconductor and a second semiconductor which are MOSFETs. The first semiconductor and the second semiconductor are controlled by switching by the rectifier.

In one embodiment of the invention, the control circuit includes a first transistor and a second transistor which are MOSFETs. The first transistor and the second transistor are controlled by switching by the router.

In one embodiment of the invention, the control circuit includes equipment including electronics used on the aircraft.

The control circuit for achieving the object of the present invention is shown in the accompanying figures.

### BRIEF DESCRIPTION OF THE DRAWINGS

FIG. 1—Schematic view of the controller.

FIG. 2—Schematic view of the control circuit half wave low side control.

FIG. 3—Schematic view of the control circuit half wave high side control.

FIG. 4—Schematic view of the control circuit center tapped full wave control.

FIG. 5—Schematic view of the control circuit full wave rectification.

The parts in the figures are numbered one by one and the equivalents of these numbers are given below.
1. Control circuit
2. Equipment
3. Source
4. First semiconductor
5. Controller
   501. Rectifier
   502. Strain gauge
   503. Current meter
   504. Router
6. First transistor
7. Resistance
8. Capacitor
9. Second semiconductor
10. Second transistor
11. Third semiconductor
12. Second rectifier
(C) Circuit
(T) Transformer
(G) Soil
(I) Introduction
(O) Exit

### DETAILED DESCRIPTION OF THE EMBODIMENTS

Control circuit (1), at least one equipment (2) configured to perform the function specified by the manufacturer, at least one source (3) connected to the equipment (2) and being a source of alternating current supplying the equipment (2) by supplying voltage to the equipment (2), a circuit (C), the input (I) of which is connected to the source (3) and the output (O) of which is connected to the equipment (2) and which enables control of the voltage and current transmitted from the source (3) to the equipment (2), contained in the circuit (C), a first semiconductor (4) connected to the source (3) and having a switching function, at least one controller (5) connected to the first semiconductor (4) in the circuit (C), controlling the operation of the first semiconductor (4) by controlling the current and voltage on the legs of the first semiconductor (4), and switching the first semiconductor (4) so that the first semiconductor (4) converts the alternating current transmitted by the source (3) into direct current.

The control circuit (1) of the invention includes at least one first transistor (6) which is directly connected to the first semiconductor (4) so as to be connected to the controller (5) so as to be connected back-to-back with the first semiconductor (4), the first semiconductor (4) converts the alternating current transmitted by the source (3) into direct current, which is switched by the controller (5) to limit the current according to the reference value determined by the user and to regulate the voltage at the level determined by the user, thus enabling the equipment (2) to be supplied at the current and voltage values determined by the user and/or the manufacturer.

There is equipment (2) which performs the function predetermined by the manufacturer. The equipment (2) is electronic and the equipment (2) is powered by the source (3), which is an alternating current/voltage source. Between the source (3) and the equipment (2) is the circuit (C), which controls the power signal transmitted from the source (3) to the equipment (2). The first semiconductor (4) is located in circuit (C) and rectifies the alternating current from source (3) into direct current. A controller (5) is connected to the first semiconductor (4) and controls the legs of the first semiconductor (4) to convert the alternating current into direct current.

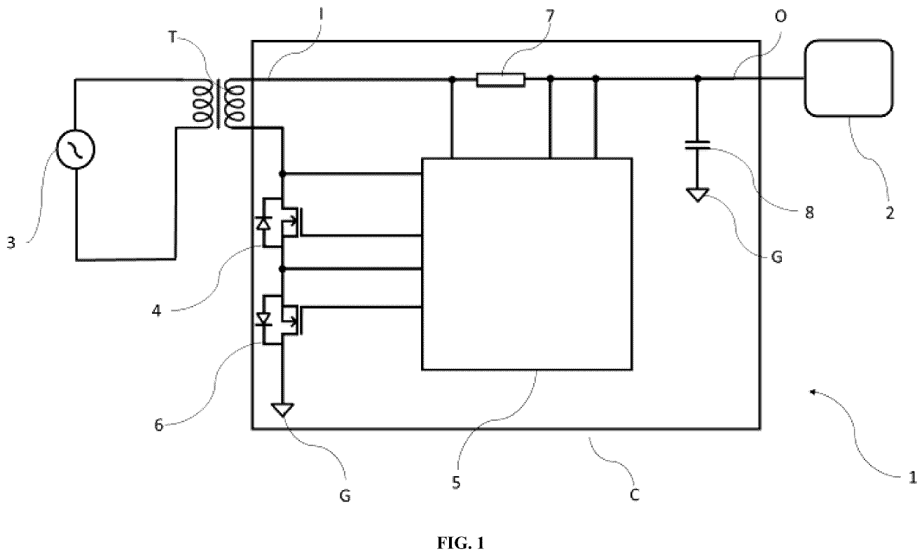

The first transistor (6) is connected to the controller (5) in a back-to-back connection with the first semiconductor (4). There is no electronic unit between the first transistor (6) and the first semiconductor (4). The alternating current transmitted from the source (3) to the equipment (2) is converted into direct current by means of the first semiconductor (4). If the converted direct current exceeds the current and voltage values predetermined by the manufacturer, it is limited and regulated by the first transistor (6). In this way, the equipment (2) operates at the voltage and current values predetermined by the manufacturer (FIG. 1).

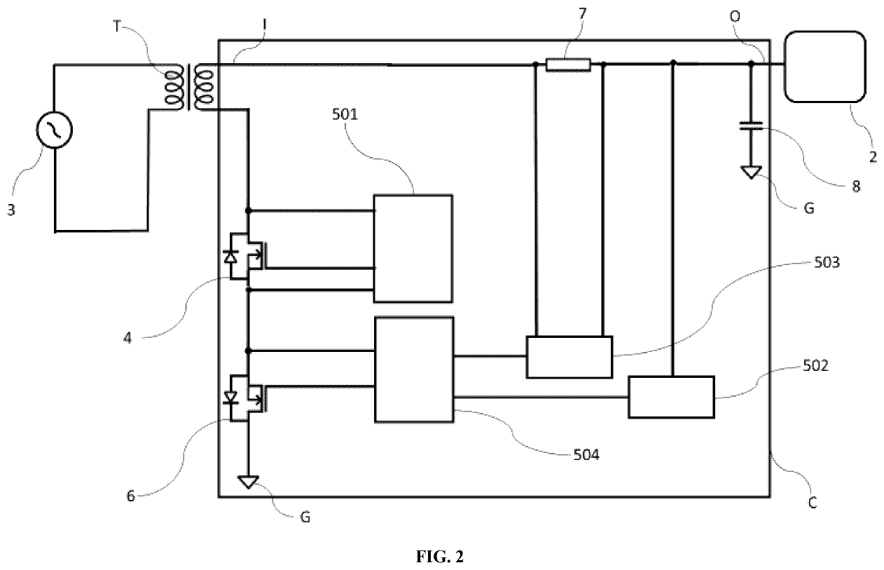

In one embodiment of the invention, the control circuit (1) includes at least one rectifier (501) included in the controller (5) and directly connected to the first semiconductor (4), which controls only the operation of the first semiconductor (4) and enables the first semiconductor (4) to be rectified by converting alternating current into direct current. In this way, conversion from alternating current to direct current is achieved with high efficiency (FIG. 2).

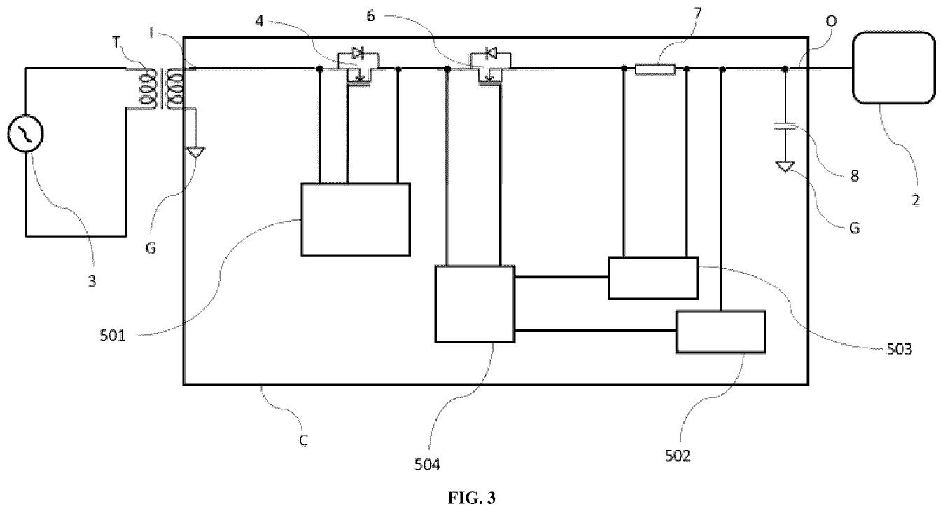

In one embodiment of the invention, the control circuit (1) includes at least one current meter (503) in the controller (5) for measuring a current value at the ends of the circuit (C) specified by the manufacturer, and at least one voltage meter (502) in the controller (5) for measuring a voltage value at the ends of the circuit (C) specified by the manufacturer, at least one router (504) connected to the current meter (503) and the voltage meter (502), which controls the current transmitted to the first transistor (6) by means of the current and voltage measured from the current meter (503) and the voltage meter (502), thereby switching the first transistor (6) and causing the first transistor (6) to be switched on or off. In this way, it is ensured that the equipment (2) operates at the current and voltage values specified by the manufacturer. (FIG. 2, FIG. 3)

In one embodiment of the invention, the control circuit (1) includes a router (504) including current and voltage threshold data specified by the manufacturer such that the equipment (2) operates at current and voltage values specified by the manufacturer, a router (504) which, in the event that the current value or voltage value measured at the output (O) of the circuit (C) exceeds a threshold value determined by the manufacturer, controls the operation of the equipment (2) by limiting the current at the output (O) of the circuit (C) and regulating the voltage, thereby preventing the current from being transmitted to the ground (G) connected to the first transistor (6) by placing the first transistor (6) in the cut-off state. In this way, the current and voltage values measured at the output (O) of the circuit (C) are dynamically compared with the threshold values and damage to the equipment (2) is prevented.

In one embodiment of the invention, the control circuit (1) includes at least one resistor (7) in the circuit (C), which enables a current to be measured from the output (O) of the circuit (C) by means of a current meter (503) at the end of the circuit (C) close to the output (O) of the circuit (C). The voltage is measured at the output (O) of the circuit (C) by means of the voltage meter (502). The resistor (7) is located in the circuit (C) in close proximity to the equipment (2) and there is no electronic unit between it and the equipment (2). In this way, current and voltage are measured at the output (O) of the circuit (C) with high efficiency.

In one embodiment of the invention, the control circuit (1) includes at least one capacitor (8) located at the output (O) of the circuit (C) so as to be directly connected to the equipment (2) and fed/charged by the equipment (2), which, in the event that at least one of the current or voltage values measured at the output (O) of the circuit (C) exceeds the threshold values determined by the manufacturer, feeds the equipment (2) with the energy stored in the equipment (2) and ensures that the equipment (2) continues to operate for the period determined by the manufacturer. The capacitor (8) acts as a filter at the output (O) of the circuit (C).

In one embodiment of the invention, the control circuit (1) includes a first semiconductor (4) and a first transistor (6) for converting alternating current transmitted from the source (3) to the equipment (2) into direct current, and a first semiconductor (4) and a first transistor (6) for limiting the current and regulating the voltage measured at the output (O) of the circuit (C), the first semiconductor (4) and the first transistor (6) being arranged back-to-back to enable current rectification and current limiting-voltage regulation. In this way, high efficiency alternating current to direct current conversion, current limiting and voltage regulation are achieved.

In one embodiment of the invention, the control circuit (1) includes a first semiconductor (4) for rectifying the positive or negative current for the voltage or current transmitted by the source (3) to the equipment (2), a first transistor (6) for limiting the positive or negative current for the voltage or current transmitted by the source (3) to the equipment (2), and a first transistor (4) for regulating the positive voltage by adjusting the positive voltage value, thereby providing voltage or current control for a half-wave which is the positive or negative portion of the voltage or current transmitted from the source (3) to the equipment (2). In this way, the current is limited and the voltage is regulated by means of a single electronic conductive unit.

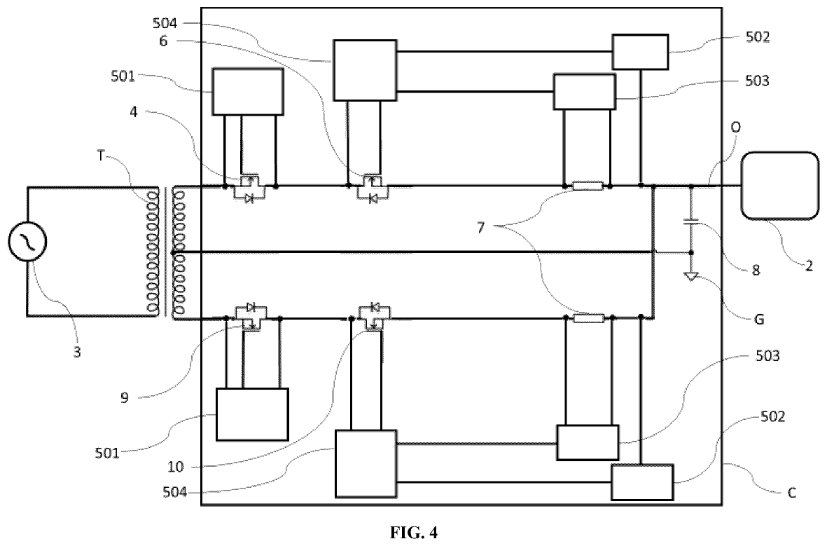

In one embodiment of the invention, the control circuit (1) includes at least one second transistor (10) and at least one second semiconductor (9), connected to the first semiconductor (4) and the first transistor (6), connected to each other in a back-to-back architecture so as to enable full-wave voltage or current control such that the voltage or current transmitted by the source (3) to the equipment (2) has a positive and a negative portion. The rectifier (501), which enables the first semiconductor (4) and the second semiconductor (9) to convert the alternating current transmitted by the source (3) to direct current as a full wave in a positive and negative manner, and the router (504) connected to the first transistor (6) and the second transistor (10), which enables the first transistor (6) and the second transistor (10) to limit the current converted from alternating current to direct current by the first semiconductor (4) and the second semiconductor (9), and to regulate the voltage level by adjusting it. In this way, control is provided for the entire signal transmitted from the source (3) to the equipment (2) (FIG. 4).

In one embodiment of the invention, the control circuit (1) includes a source (3) for transmitting an alternating voltage or current to the circuit (C) (101), the positive region of the voltage or current being converted from alternating current to direct current by means of a first semiconductor (4) (102), converting the negative region of the voltage or current from alternating current to direct current by means of the second semiconductor (9) (103), measuring the current and voltage values at the output (O) of the circuit (C) by means of the current meter (503) and voltage meter (502) through the resistor (7) (104). The circuit (C) includes the circuit (C) that enables the process steps of comparing the current and voltage threshold values predetermined by the manufacturer in the router (504) with the current and voltage values measured through the resistor (7) (105), controlling the first transistor (6) and the second transistor (10) to be in conduction or cut-off by controlling the voltage or current by the router (504), and supplying the equipment (2) by obtaining the voltage or current determined by the manufacturer (106).

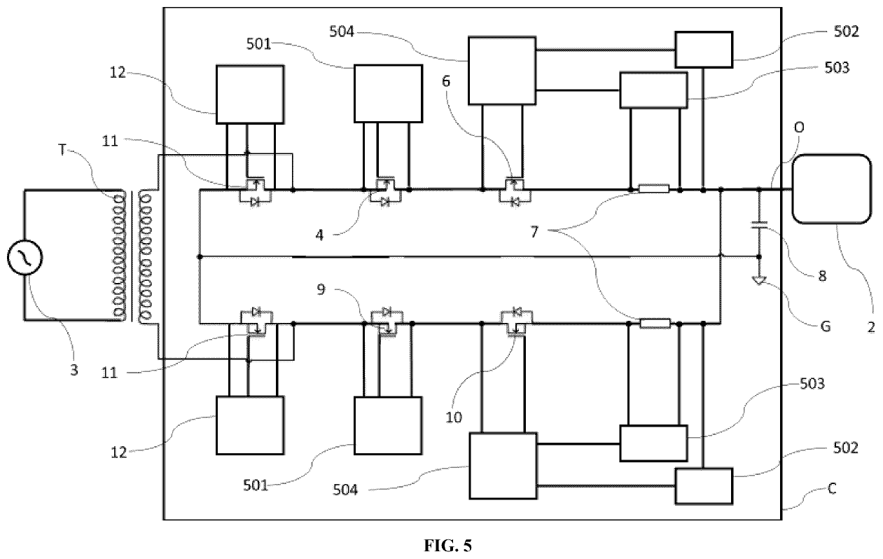

In one embodiment of the invention, the control circuit (1) includes at least one second rectifier (11) located in the circuit (C) on the high voltage side and/or on the low voltage side, at least one third semiconductor (12) located in the circuit (C) on the high voltage side and/or on the low voltage side, controlled by the second rectifier (11), allowing rectification of the current and voltage transmitted by the source (3) by means of the first semiconductor (4) and the second semiconductor (9), allowing limiting the rectified current and regulating the voltage. This allows the circuit to be completed in a full bridge current and voltage configuration (FIG. 5).

In one embodiment of the invention, the control circuit (1) includes a source (3) on the primary winding side of the electromagnetically isolated transformer (T) (transformer) and a circuit (C) forming the secondary winding side, whereby the alternating current transmitted by the source (3) to the equipment (2) is converted into direct current and the current limiting and voltage regulation operations of the current or voltage converted into direct current are performed on the secondary winding side of the transformer (T). In this way, current rectification, limiting of direct current and regulation of voltage level are provided on the secondary side of the transformer (T), which is completely independent of the primary side.

In one embodiment of the invention, the control circuit (1) includes a first semiconductor (4) and a second semiconductor (9) which are MOSFETs and which provide conversion of alternating current switched by the rectifier (501) and transmitted by the source (3) to the equipment (2) into direct current.

In one embodiment of the invention, the control circuit (1) includes a first transistor (6) and a second transistor (10), which are MOSFETs, for regulating the voltage and limiting the current.

In one embodiment of the invention, the control circuit (1) includes electronic equipment (2) configured for use in an aircraft.

1. A control circuit, comprising:
at least one equipment, configured to perform a function specified by a manufacturer,
at least one source, connected to the equipment and configured to be a source of an alternating current supplying the equipment by supplying voltage to the equipment,
a circuit, wherein an input of the circuit is connected to the source, an output of the circuit is connected to the equipment, and the circuit enables control of the voltage and current transmitted from the source to the equipment,
a first semiconductor in the circuit, connected to the source and having a switching function,
at least one controller in the circuit, connected to the first semiconductor, controlling an operation of the first semiconductor by controlling the current and voltage at legs of the first semiconductor, and switching the first semiconductor so that the first semiconductor converts the alternating current transmitted by the source into a direct current, and
at least one first transistor, wherein the first transistor is directly connected to the controller so as to be connected back-to-back with the first semiconductor, the first transistor is switched by the controller to limit the current according to a reference value determined by a user and to regulate the voltage at a level determined by the user when the first semiconductor converts the alternating current transmitted by the source into the direct current, thereby allowing the equipment to be supplied at the current and voltage values determined by the user and/or the manufacturer.

2. The control circuit according to claim 1, wherein
at least one rectifier included in the controller is directly connected to the first semiconductor, and configured for rectifying the first semiconductor by converting the alternating current into the direct current by controlling only the operation of the first semiconductor.

3. The control circuit according to claim 1, wherein
at least one current meter is located in the controller and enables current to be measured at terminals of the circuit specified by the manufacturer,
at least one voltage meter is located in the controller and enables voltage to be measured at the terminals of the circuit specified by the manufacturer, and
at least one router is connected to the current meter and the voltage meter, and configured for controlling the current delivered to the first transistor by current and voltage measured from the current meter and the voltage meter, thereby switching the first transistor so that the first transistor is switched on or off.

4. The control circuit according to claim 3, wherein
the router contains current and voltage threshold data specified by the manufacturer so that the equipment operates at the current and voltage values specified by the manufacturer, controls an operation of the equipment by limiting the current and regulating the voltage at the output of the circuit, thereby controlling the operation of the equipment by limiting the current and regulating the voltage at the output of the circuit when the current value or voltage value measured at the output of the circuit exceeds a threshold value determined by the manufacturer, by placing the first transistor in a cut-off state and preventing the current from being transmitted to ground connected to the first transistor.

5. The control circuit according to claim 3, wherein
at least one resistor is located in the circuit, and enables the circuit to measure a current value at the output of the circuit by a current meter at an end of the circuit close to the output of the circuit.

6. The control circuit according to claim 1, wherein
at least one capacitor is located at the output of the circuit so as to be directly connected to the equipment and fed/charged by the equipment, and, in an event that at least one of the current or voltage values measured at the output of the circuit exceeds threshold values specified by the manufacturer, feeds the equipment with an energy stored in the equipment so that the equipment continues to operate for a period specified by the manufacturer.

7. The control circuit according to claim 1, wherein
the first semiconductor and the first transistor are positioned back-to-back, enable current rectification and current limiting-voltage regulation operations to be performed, by the first semiconductor converting the alternating current transmitted from the source to the equipment into the direct current and the first transistor limiting the current and regulating the voltage measured at the output of the circuit.

8. The control circuit according to claim 1, wherein
the first semiconductor is configured for rectifying a positive or negative current for the voltage or current transmitted by the source to the equipment, and
the first transistor is configured for limiting the positive or negative current for the voltage or current transmitted by the source to the equipment, and for controlling the voltage or current for a half-wave which is a positive or negative part of the voltage or current transmitted from the source to the equipment, whereby a positive voltage value is regulated by adjusting the positive voltage value.

9. The control circuit according to claim 3, wherein
at least one second transistor and at least one second semiconductor are located in the circuit, connected to the first semiconductor and the first transistor, connected to each other in a back-to-back architecture so as to enable full-wave voltage or current control such that the voltage or current having a positive part and a negative part is transmitted by the source to the equipment,
a rectifier enables the first semiconductor and the second semiconductor to convert the alternating current transmitted by the source to the direct current as a full wave with positive and negative, and is connected to the first transistor and the second transistor, and
a router is connected to the first transistor and the second transistor and configured for limiting the current converted from the alternating current to the direct current by the first semiconductor and the second semiconductor and for regulating a voltage level by adjusting the voltage level.

10. The control circuit according to claim 9, wherein
the circuit is configured for performing process steps:
transmitting alternating voltage or current from the source to the circuit,
converting a positive region of voltage or current from the alternating current to the direct current by the first semiconductor,
converting a negative region of the voltage or current from the alternating current to the direct current by the second semiconductor,
measuring current and voltage values at the output of the circuit by the current meter and the voltage meter through the resistor,
comparing current and voltage thresholds predetermined by the manufacturer in the router with the current and voltage values measured through the resistor, and
controlling the first transistor and the second transistor to be in conduction or cut-off by controlling the voltage or current by the router and supplying the equipment by obtaining the voltage or current specified by the manufacturer.

11. The control circuit according to claim 9, wherein
at least one second rectifier is located in circuit on a high voltage side and/or on a low voltage side, and
at least one third semiconductor is located in the circuit on the high-voltage side and/or the low-voltage side, and controlled by the second rectifier, allows the current and voltage transmitted by the source to be rectified by the first semiconductor and the second semiconductor, and allows a rectified current to be limited and the voltage to be regulated.

12. The control circuit according to claim 1, wherein
the source is located on a primary winding side of an electromagnetically isolated transformer, and the circuit forms the secondary winding side, whereby the alternating current transmitted by the source to the equipment is converted into the direct current and current limiting and voltage regulation operations of the current or voltage converted into the direct current are performed on the secondary winding side of the transformer.

13. The control circuit according to claim 9, wherein the first semiconductor and the second semiconductor are MOSFETs and switched by the rectifier to convert the alternating current transmitted by the source to the equipment into the direct current.

14. The control circuit according to claim 9, wherein the first transistor and the second transistor are MOSFETs and configured for providing regulation of the voltage and limiting of the current.

15. The control circuit according to claim 1, wherein the equipment is electronic and configured for use in the aircraft.

16. The control circuit according to claim 2, wherein
at least one current meter is located in the controller and enables current to be measured at terminals of the circuit specified by the manufacturer,
at least one voltage meter is located in the controller and enables voltage to be measured at the terminals of the circuit specified by the manufacturer, and
at least one router is connected to the current meter and the voltage meter, and configured for controlling the current delivered to the first transistor by current and voltage measured from the current meter and the voltage meter, thereby switching the first transistor so that the first transistor is switched on or off.

17. The control circuit according to claim 4, wherein
at least one resistor is located in the circuit, and enables the circuit to measure a current value at the output of the circuit by a current meter at an end of the circuit close to the output of the circuit.

18. The control circuit according to claim 2, wherein
at least one capacitor is located at the output of the circuit so as to be directly connected to the equipment and fed/charged by the equipment, and, in an event that at least one of the current or voltage values measured at the output of the circuit exceeds threshold values specified by the manufacturer, feeds the equipment with an energy stored in the equipment so that the equipment continues to operate for a period specified by the manufacturer.

19. The control circuit according to claim 3, wherein
at least one capacitor is located at the output of the circuit so as to be directly connected to the equipment and fed/charged by the equipment, and, in an event that at least one of the current or voltage values measured at the output of the circuit exceeds threshold values specified by the manufacturer, feeds the equipment with an energy stored in the equipment so that the equipment continues to operate for a period specified by the manufacturer.

20. The control circuit according to claim 4, wherein
at least one capacitor is located at the output of the circuit so as to be directly connected to the equipment and fed/charged by the equipment, and, in an event that at least one of the current or voltage values measured at the output of the circuit exceeds threshold values specified by the manufacturer, feeds the equipment with an energy stored in the equipment so that the equipment continues to operate for a period specified by the manufacturer.
